(19) United States
(12) Patent Application Publication
(10) Pub. No.: US 2026/0236069 A1
(43) Pub. Date: Aug. 13, 2026

(54) PORTABLE ELECTRONIC DEVICE

(71) Applicant: Acer Incorporated, New Taipei City (TW)

(72) Inventors: Jia-Yu LIN, New Taipei City (TW); Chih-Chiang CHEN, New Taipei City (TW); Chueh-Pin KO, New Taipei City (TW)

(21) Appl. No.: 19/273,542

(22) Filed: Jul. 18, 2025

(30) Foreign Application Priority Data
Feb. 7, 2025 (TW) 114104527

(51) Int. Cl. G06F 1/16

(52) U.S. Cl. CPC G06F 1/1669

(57) ABSTRACT

A portable electronic device includes a housing, a first magnetic module, and a detachable input device. The housing has an upper surface and an accommodation recess, and the accommodation recess is recessed from the upper surface. The first magnetic module is disposed in the housing. The detachable input device is detachably installed in the accommodation recess or separated from the accommodation recess, and the detachable input device has a second magnetic module. When the detachable input device is installed in the accommodation recess, the portable electronic device provides an activation signal to the detachable input device so that the second magnetic module is activated and generates a magnetic attraction force with the first magnetic module to fix the detachable input device in the accommodation recess.

### CROSS REFERENCE TO RELATED APPLICATIONS

This application claims the benefit of Taiwan Patent Application No. 114104527, filed on Feb. 7, 2025, the entirety of which is incorporated by reference herein.

### BACKGROUND OF THE INVENTION

### Field of the Disclosure

The present disclosure relates to a portable electronic device, and in particular it relates to a portable electronic device having a detachable input device.

### Description of the Related Art

With the development of science and technology, many electronic devices (such as augmented reality glasses) are popular products that have become increasingly common.

Due to some advanced needs, such as playing games, users typically need additional accessories, such as a game joystick or a controller and so on, to facilitate gameplay through these accessories. However, since these additional accessories are not fixed to the notebook computer, they must be purchased separately and are prone to being lost during transportation.

Therefore, how to design an electronic device capable of integrating accessories is a topic that needs to be discussed.

### BRIEF SUMMARY OF THE INVENTION

Accordingly, one objective of the present disclosure is to provide a portable electronic device to solve the above problem.

The present disclosure provides a portable electronic device that includes a housing, a first magnetic module, and a detachable input device. The housing has an upper surface and an accommodation recess, and the accommodation recess is recessed from the upper surface. The first magnetic module is disposed in the housing. The detachable input device is detachably installed in the accommodation recess or separated from the accommodation recess, and the detachable input device has a second magnetic module. When the detachable input device is installed in the accommodation recess, the portable electronic device provides an activation signal to the detachable input device so that the second magnetic module is activated and generates a magnetic attraction force with the first magnetic module to fix the detachable input device in the accommodation recess.

According to some embodiments, the portable electronic device further includes a first control circuit, the detachable input device further includes a second control circuit, and when the second control circuit receives the activation signal from the first control circuit, the second control circuit provides a first current to the second magnetic module to generate the magnetic attraction force.

According to some embodiments, when the second control circuit receives a release signal from the first control circuit, the second control circuit provides a second current to the second magnetic module to generate a magnetic repulsive force between the second magnetic module and the first magnetic module, thereby driving the detachable input device to detach from the accommodation recess. The direction of the second current is opposite to the direction of the first current.

According to some embodiments, the second magnetic module has a first coil to a fourth coil, the first coil and the second coil are located on a first side, the third coil and the fourth coil are located on a second side, and the second side is opposite to the first side.

According to some embodiments, when the second control circuit receives a release signal from the first control circuit, the second control circuit provides a second current to the first coil and the second coil to generate a first magnetic repulsive force between the combination of the first coil and the second coil, and the first magnetic module, and the second control circuit further provides a third current to the third coil and the fourth coil to generate a second magnetic repulsive force between the combination of the third coil and the fourth coil, and the first magnetic module.

According to some embodiments, the direction of the third current is the same as the direction of the second current, the direction of the second current is opposite to a direction of the first current, and the second magnetic repulsive force is greater than the first magnetic repulsive force.

According to some embodiments, the first magnetic module has four magnetic components corresponding respectively to the first coil to the fourth coil, and the portable electronic device further includes a first haptic module to a fourth haptic module respectively connected to the four magnetic components.

According to some embodiments, each of the first haptic module to the fourth haptic module has a haptic pressure sensor which is configured to sense a force applied by an external object to the detachable input device.

According to some embodiments, each of the first haptic module to the fourth haptic module further includes an insulation component which is disposed between the corresponding haptic pressure sensor and the magnetic component. The insulation component is made of a non-magnetic material.

According to some embodiments, each of the first haptic module to the fourth haptic module further has a transmit element which is connected between the corresponding haptic pressure sensor and the magnetic component.

According to some embodiments, each of the first haptic module to the fourth haptic module further has a positioning component which is fixedly disposed on the corresponding haptic pressure sensor, the transmit element has a columnar structure, and the positioning component is configured to position the transmit element.

According to some embodiments, the detachable input device further includes a first vibrator, each of the first haptic module to the fourth haptic module further includes a second vibrator, and vibration generated by the second vibrator is superimposed on vibration generated by the first vibrator.

According to some embodiments, the detachable input device further includes a touchpad module, and when the first haptic module to the fourth haptic module sense that the external object applies a force to the touchpad module and moves from a first force application position to a second force application position and finally stops at a third force application position on the touchpad module, the first control circuit receives sensing signals from the first haptic module to the fourth haptic module and correspondingly outputs a sensing result to the second control circuit.

According to some embodiments, the second control circuit is configured to compare the sensing result with a lookup table to obtain a comparison result, and the first control circuit outputs a vibration signal to the second vibrator in at least one of the first haptic module to the fourth haptic module according to the comparison result before the external object reaches the third force application position.

According to some embodiments, the position of the second vibrator that receives the vibration signal corresponds to the third force application position.

According to some embodiments, an application executed by the portable electronic device is configured to output a prompt signal to the first control circuit, and the first control circuit outputs at least one vibration signal to the second vibrator of at least one of the first haptic module to the fourth haptic module according to the prompt signal, so that the second vibrator vibrates.

According to some embodiments, the detachable input device has a top surface and a bottom surface, and the top surface is opposite to the bottom surface. A touchpad module is disposed on the top surface, and a button module is disposed on the bottom surface.

According to some embodiments, when the detachable input device is installed in the accommodation recess, the touchpad module of the detachable input device provides a touchpad function, and when the detachable input device is separated from the accommodation recess, the button module of the detachable input device provides a button input function which is configured to provide an input signal to the portable electronic device in a wireless manner.

According to some embodiments, a first connector is disposed in the accommodation recess and has a plurality of first electrical contacts, and a second connector is disposed on the detachable input device and has a plurality of second electrical contacts. When the detachable input device is installed in the accommodation recess, the second electrical contacts are in contact with and are electrically connected to the first electrical contacts, so that the portable electronic device sends the activation signal accordingly.

According to some embodiments, the first connector or the second connector is a pogo pin connector.

The present disclosure provides a portable electronic device, which may include a housing and a detachable input device. The detachable input device is detachably installed in an accommodation recess of the housing. When the detachable input device is installed in the housing, the second magnetic module of the detachable input device may generate a magnetic attraction force with the first magnetic module in the housing, so that the detachable input device may be fixed in the accommodation recess.

When the user wants to remove the detachable input device from the accommodation recess, the user can perform an operation gesture on the touchpad module to trigger the second magnetic module and the first magnetic module to generate a magnetic repulsive force, thereby pushing the detachable input device out of the accommodation recess. In addition, a first vibrator is disposed in the detachable input device, and a plurality of haptic modules are further disposed in the housing, each of which has a second vibrator.

When the user operates the touchpad module of the detachable input device and executes a specific application, in certain scenarios of the application, the application will send a signal to notify the first control circuit and the second control circuit to control the first vibrator and the second vibrator to generate vibration together. Since the vibration generated by the second vibrator can be superimposed on the vibration generated by the first vibrator (for example, the phases of the two vibrators are substantially the same), it can provide the user with more obvious vibration feedback, thereby solving the problem of insufficient vibration feedback of a single vibrator.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a top view of a portable electronic device 100 and a detachable input device 200 according to an embodiment of the present disclosure.

FIG. 2 is a functional block diagram of the portable electronic device 100 and the detachable input device 200 according to an embodiment of the present disclosure.

FIG. 3 is a schematic diagram of the detachable input device 200 in another viewing angle according to an embodiment of the present disclosure.

FIG. 4 is a cross-sectional schematic diagram of the portable electronic device 100 and the detachable input device 200 according to an embodiment of the present disclosure.

FIG. 5 is a schematic diagram illustrating that the detachable input device 200 is pushed out of the accommodation recess 1022 according to another embodiment of the present disclosure.

FIG. 6 is a schematic diagram showing that the haptic modules generate vibrations in response to an application according to an embodiment of the present disclosure.

FIG. 7 is a schematic diagram showing that the haptic modules generate vibrations in response to an application according to another embodiment of the present disclosure.

FIG. 8 is a schematic diagram showing that the haptic modules generate vibrations in response to an application according to another embodiment of the present disclosure.

FIG. 9 is a schematic diagram showing that the haptic modules generate vibrations in response to an application according to an embodiment of the present disclosure.

FIG. 10 is a schematic diagram showing that the haptic modules generate vibration in response to an operation gesture according to an embodiment of the present disclosure.

### DETAILED DESCRIPTION OF THE INVENTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are in direct contact, and may also include embodiments in which additional features may be disposed between the first and second features, such that the first and second features may not be in direct contact.

In addition, the present disclosure may repeat reference numerals and/or letters in the various examples. This repetition is for the purpose of simplicity and clarity and does not in itself dictate a relationship between the various embodiments and/or configurations discussed. Moreover, the formation of a feature on, connected to, and/or coupled to another feature in the present disclosure that follows may include embodiments in which the features are in direct contact, and may also include embodiments in which additional features may be disposed interposing the features, such that the features may not be in direct contact. In addition, spatially relative terms, for example, “vertical,” “above,” “over,” “below,”, “bottom,” etc. as well as derivatives thereof (e.g., “downwardly,” “upwardly,” etc.) are used in the present disclosure for ease of description of one feature's relationship to another feature. The spatially relative terms are intended to cover different orientations of the device, including the features.

Unless defined otherwise, all technical and scientific terms used herein have the same meaning as commonly understood by one of ordinary skill in the art to which this disclosure belongs. It should be appreciated that each term, which is defined in a commonly used dictionary, should be interpreted as having a meaning conforming to the relative skills and the background or the context of the present disclosure, and should not be interpreted in an idealized or overly formal manner unless defined otherwise.

Use of ordinal terms such as “first”, “second”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

In addition, in some embodiments of the present disclosure, terms concerning attachments, coupling and the like, such as “connected” and “interconnected”, refer to a relationship wherein structures are secured or attached to one another either directly or indirectly through intervening structures, as well as both movable or rigid attachments or relationships, unless expressly described otherwise.

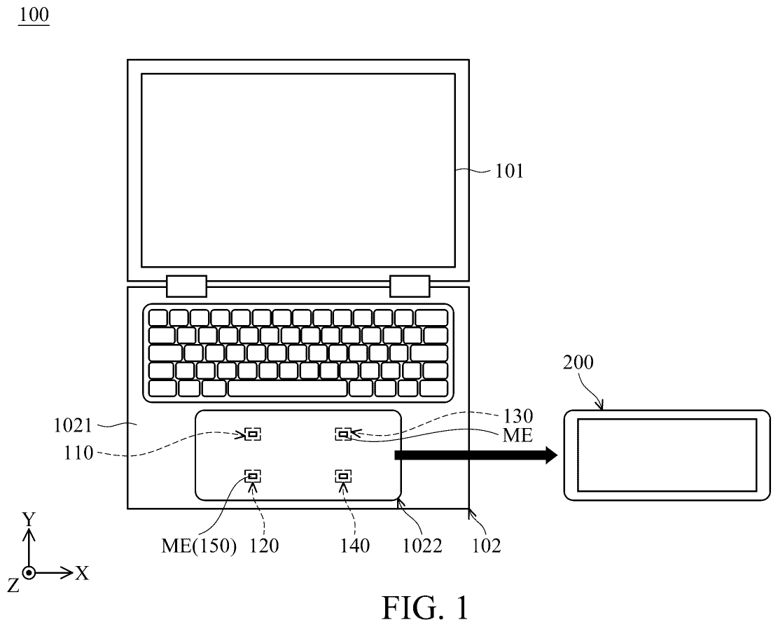

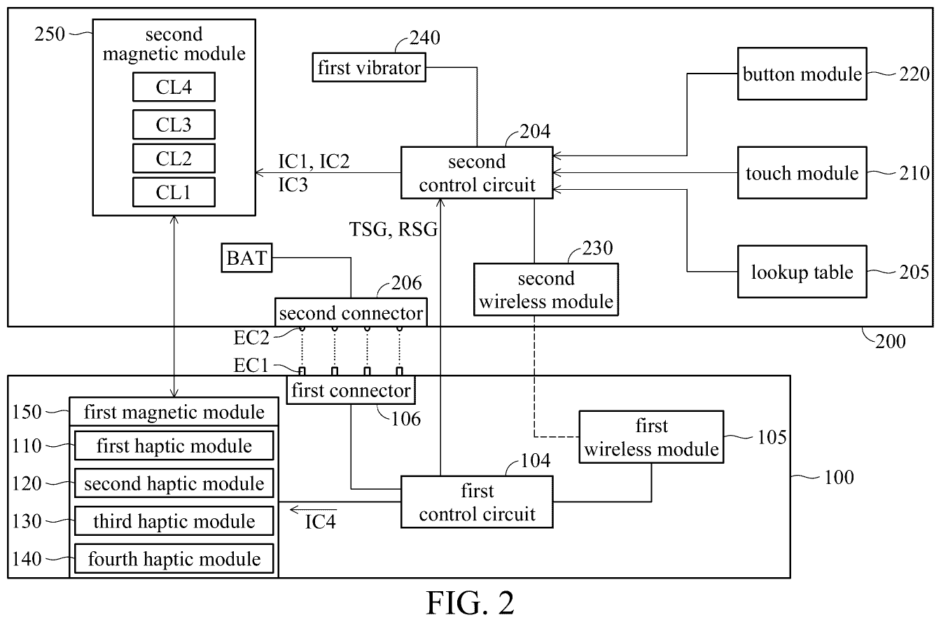

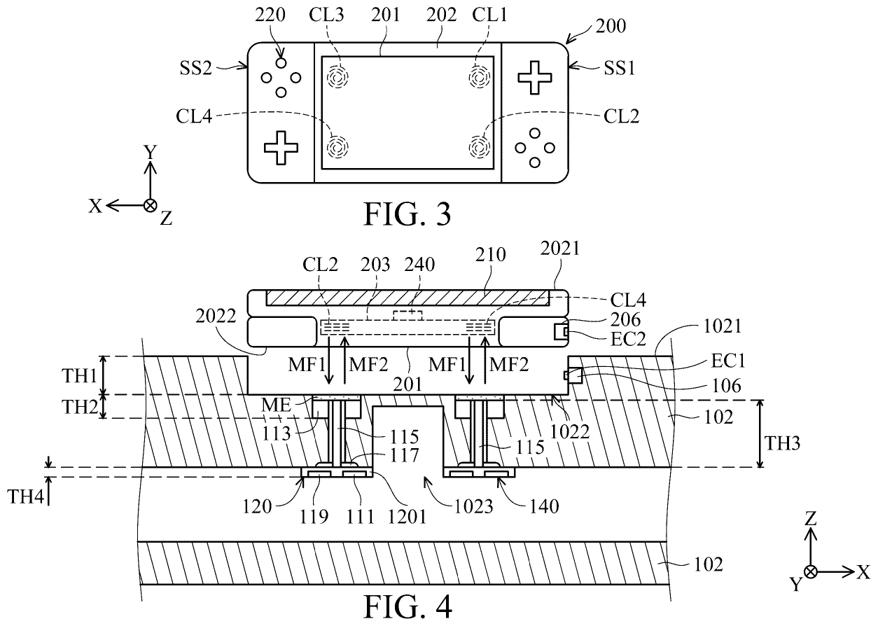

Please refer to FIG. 4, FIG. 1 is a top view of a portable electronic device 100 and a detachable input device 200 according to an embodiment of the present disclosure, FIG. 2 is a functional block diagram of the portable electronic device 100 and the detachable input device 200 according to an embodiment of the present disclosure, FIG. 3 is a schematic diagram of the detachable input device 200 in another viewing angle according to an embodiment of the present disclosure, and FIG. 4 is a cross-sectional schematic diagram of the portable electronic device 100 and the detachable input device 200 according to an embodiment of the present disclosure.

In this embodiment, the portable electronic device 100 is a notebook computer, but it is not limited thereto. The portable electronic device 100 may include a display screen 101 and a housing 102. The housing 102 may have an upper surface 1021 and an accommodation recess 1022. The accommodation recess 1022 is formed by being recessed from the upper surface 1021, as shown in FIG. 4.

Furthermore, as shown in FIG. 3 and FIG. 4, the detachable input device 200 has an outer casing 202, which has a top surface 2021 and a bottom surface 2022, and the top surface 2021 is opposite to the bottom surface 2022. A touchpad module 210 is disposed on the top surface 2021, and a button module 220 is disposed on the bottom surface 2022. In addition, in this embodiment, the detachable input device 200 may further include a screen module 201 for displaying image information, but in some embodiments, the screen module 201 may be omitted.

When the detachable input device 200 is installed in the accommodation recess 1022, the touchpad module 210 is configured to provide a touchpad function. When the detachable input device 200 is separated from the accommodation recess 1022, the button module 220 is configured to provide a button input function.

When the button input function is performed, the detachable input device 200 is configured to provide an input signal to the portable electronic devices 100 in a wireless manner. For example, the portable electronic device 100 further includes a first control circuit 104 and a first wireless module 105, and the detachable input device 200 further includes a second control circuit 204 and a second wireless module 230.

The second control circuit 204 can transmit the aforementioned input signal to the first control circuit 104 through the second wireless module 230 and the first wireless module 105. The first wireless module 105 and the second wireless module 230 may be Bluetooth modules or Wi-Fi modules, but they are not limited thereto. In addition, the first control circuit 104 is, for example, a central processing unit, and the second control circuit 204 is, for example, a microcontroller or a single-chip processor, but they are not limited thereto.

In order to facilitate the detachable input device 200 to be firmly installed in the accommodation recess 1022 or separated from the accommodation recess 1022 in a detachable manner, the portable electronic device 100 may further include a first magnetic module 150 which his disposed in the housing 102, and the detachable input device 200 may include a second magnetic module 250 corresponding to the first magnetic module 150.

Specifically, as shown in FIG. 1, the first magnetic module 150 may include four magnetic components ME, which are buried in the housing 102 and located below the accommodation recess 1022. In this embodiment, the magnetic components ME are, for example, magnets, and an upper surface of each of the magnetic components ME is exposed from the housing 102, but the present disclosure is not limited thereto. In other embodiments, the upper surface of the magnetic components ME may be covered by the housing 102.

When the user places the detachable input device 200 in the accommodation recess 1022, the portable electronic devices 100 provides an activation signal TSG to the detachable input device 200, so that the second magnetic module 250 is activated and generates a magnetic attraction force MF1 between the second magnetic module 250 and the first magnetic module 150, so as to fix the detachable input device 200 in the accommodation recess 1022.

Specifically, as shown in FIG. 2 and FIG. 4, a first connector 106 is disposed in the accommodation recess 1022, which has a plurality of first electrical contacts EC1, and a second connector 206 is disposed on the detachable input device 200, which has a plurality of second electrical contacts EC2 corresponding to these first electrical contacts EC1.

In this embodiment, one of the first connector 106 and the second connector 206 may be a pogo pin connector, and the other one can be a connector having electrical contacts corresponding to the pogo pin, but they are not limited thereto.

When the detachable input device 200 is installed in the accommodation recess 1022, the second electrical contacts EC2 are in contact with and are electrically connected to the first electrical contacts EC1. At this time, the first control circuit 104 detects the aforementioned electrical connection and sends the activation signal TSG to the second control circuit 204 accordingly. In addition, the first control circuit 104 can also charge a battery BAT of the detachable input device 200 through the first connector 106 and the second connector 206.

When the second control circuit 204 receives the activation signal TSG from the first control circuit 104, the second control circuit 204 provides a first current IC1 to the second magnetic module 250 to generate the aforementioned magnetic attraction force MF1.

As shown in FIG. 3 and FIG. 4, the detachable input device 200 may further include a circuit board 203 which is disposed in the outer casing 202, and the second magnetic module 250 has a first coil CL1 to a fourth coil CL4 which are disposed in the circuit board 203. That is, the first coil CL1 to the fourth coil CL4 are planar coils, but they are not limited thereto.

As shown in FIG. 3, the first coil CL1 and the second coil CL2 are located on a first side SS1, the third coil CL3 and the fourth coil CL4 are located on a second side SS2, and the second side SS2 is opposite to the first side SS1. In addition, the arrangement positions of the first coil CL1 to the fourth coil CL4 correspond to the arrangement positions of the four magnetic components ME.

When the first coil CL1 to the fourth coil CL4 receive the first current IC1, a magnetic pole that is opposite to the magnetic pole of the magnetic component ME can be generated, so that the aforementioned magnetic attraction force MF1 can be generated to fix the detachable input device 200 in the accommodation recess 1022.

On the other hand, when the user wants to remove the detachable input device 200 from the accommodation recess 1022, the user can perform an operation gesture on the touchpad module 210 to cause the first control circuit 104 to send a release signal RSG to the second control circuit 204.

When the second control circuit 204 receives the aforementioned release signal RSG from the first control circuit 104, the second control circuit 204 provides a second current IC2 to the second magnetic module 250, so that the first coil CL1 to the fourth coil CL4 generate magnetic poles that are the same as magnetic poles of the magnetic component ME.

Therefore, a magnetic repulsive force MF2 is generated between the first coil CL1 to the fourth coil CL4 and the first magnetic module 150, so that the detachable input device 200 is detached from the accommodation recess 1022. The direction of the second current IC2 is opposite to the direction of the first current IC1.

For example, the second current IC2 is a negative current, and the first current IC1 is a positive current. When the magnetic repulsive force MF2 is sufficiently large, for example, larger than the weight of the detachable input device 200, the detachable input device 200 may be driven by the magnetic repulsive force MF2 to be ejected from the accommodation recess 1022, so that the user can take it out conveniently.

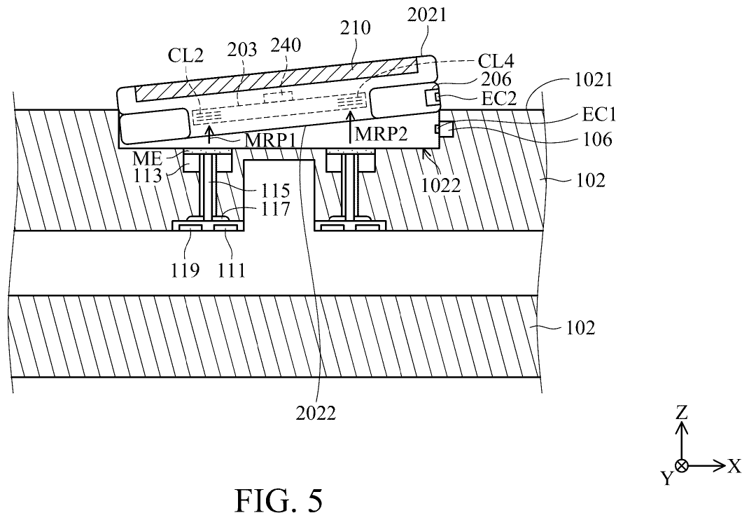

It is worth noting that the method of disassembling the detachable input device 200 is not limited to this embodiment. For example, please refer to FIG. 2 and FIG. 5. FIG. 5 is a schematic diagram illustrating that the detachable input device 200 is pushed out of the accommodation recess 1022 according to another embodiment of the present disclosure.

In this embodiment, when the second control circuit 204 receives the aforementioned release signal RSG from the first control circuit 104, the second control circuit 204 provides a second current IC2 to the first coil CL1 and the second coil CL2 to generate a first magnetic repulsive force MRP1 between the combination of the first coil CL1 and the second coil CL2, and the first magnetic module 150. In addition, the second control circuit 204 further provides a third current IC3 to the third coil CL3 and the fourth coil CL4 to generate a second magnetic repulsive force MRP2 between the combination of the third coil CL3 and the fourth coil CL4, and the first magnetic module 150, as shown in FIG. 5.

The direction of the third current IC3 is the same as the direction of the second current IC2, the direction of the second current IC2 is opposite to the direction of the first current IC1, and the amplitude of the third current IC3 is greater than the amplitude of the second current IC2.

That is, the second magnetic repulsive force MRP2 is greater than the first magnetic repulsive force MRP1. Therefore, as shown in FIG. 5, such a configuration facilitate the detachable input device 200 to pop out in an inclined manner, making it more convenient for the user to take out the detachable input device 200 from the accommodation recess 1022.

Next, please go back to FIG. 2 and FIG. 4. The portable electronic device 100 further includes a first haptic module 110 to a fourth haptic module 140 respectively connected to the four magnetic components ME. Each of the first haptic module 110 to the fourth haptic module 140 has the same structure and component configuration, and may include a haptic pressure sensor 111 which is configured to sense a force applied to the detachable input device 200 by an external object (such as the user's finger).

As shown in FIG. 4, each of the first haptic module 110 to the fourth haptic module 140 further includes an insulation component 113 which is disposed between the corresponding haptic pressure sensor 111 and the magnetic component ME.

Each of the first haptic module 110 to the fourth haptic module 140 further includes a transmit element 115 which is connected between the corresponding haptic pressure sensor 111 and the magnetic component ME. For example, as shown in FIG. 4, the second haptic module 120 has a module housing 1201, and the transmit element 115 is fixedly connected between the magnetic component ME and the module housing 1201.

Similarly, each of the first haptic module 110 to the fourth haptic module 140 may further include a positioning component 117 which is fixedly disposed on the corresponding haptic pressure sensor 111. For example, as shown in FIG. 4, the haptic pressure sensor 111 is disposed in the module housing 1201, and the positioning component 117 is fixedly disposed on the module housing 1201 to position the transmit element 115.

Specifically, the transmit element 115 has a columnar structure, and the insulation components 113 and the positioning component 117 may have a ring-shaped structure, which is sleeved over the transmit element 115 and configured to position the transmit element 115. In this embodiment, the insulation component 113, the transmit element 115 and the positioning component 117 can be made of plastic materials, such as PE, PP, ABS or PC, but they are not limited thereto. The insulation component 113, the transmit element 115, and the positioning component 117 may be connected to each other by glue, but they are not limited thereto. For example, in other embodiments, the insulation component 113, the transmit element 115, and the positioning component 117 may be integrally formed as one piece.

In this embodiment, a depth TH1 of the accommodation recess 1022 is, for example, greater than or equal to 20 mm, an overall height TH2 of the magnetic component ME and the insulation component 113 is, for example, 1 mm, a height TH3 of the transmit element 115 is, for example, 1 to 30 mm, and a height TH4 of the module housing 1201 is, for example, 1.5 to 2 mm, but they are not limited thereto.

Furthermore, as shown in FIG. 4, the detachable input device 200 further includes a first vibrator 240, and each of the first haptic module 110 to the fourth haptic module 140 may further include a second vibrator 119 which is disposed in the corresponding module housing 1201.

When the detachable input device 200 is installed in the accommodation recess 1022, the user can operate the touchpad module 210 and execute a specific application. When the application sends a signal to notify the first control circuit 104 and the second control circuit 204, the first vibrator 240 and the second vibrator 119 can be controlled to vibrate together.

Specifically, the vibration generated by the second vibrator 119 can be transmitted to the outer casing 202 through the transmit element 115 and the magnetic component ME. Based on such a configuration, the vibration generated by the second vibrator 119 can be superimposed on the vibration generated by the first vibrator 240 (for example, the phases of the two vibration are substantially the same), thereby providing the user with more obvious vibration feedback to solve the problem of insufficient feedback from a single vibrator.

In this embodiment, the first vibrator 240 and the second vibrator 119 can be, composed of, for example, a coil and a magnet (not shown in the figure), but they are not limited thereto. It is worth noting that due to the configuration of the insulation components 113, the non-magnetic insulation component 113 can isolate the influence of the magnetic field of the magnetic component ME to the second vibrator 119, so that the second vibrator 119 can still operate normally under such a configuration.

It is also worth noting that, as shown in FIG. 4, the housing 102 may further include an accommodation notch 1023 which is formed between the adjacent second haptic module 120 and fourth haptic module 140. The accommodation notch 1023 may be used to accommodate one or more electronic components (not shown), for example, to accommodate a portion of a battery or a portion of a corresponding connector.

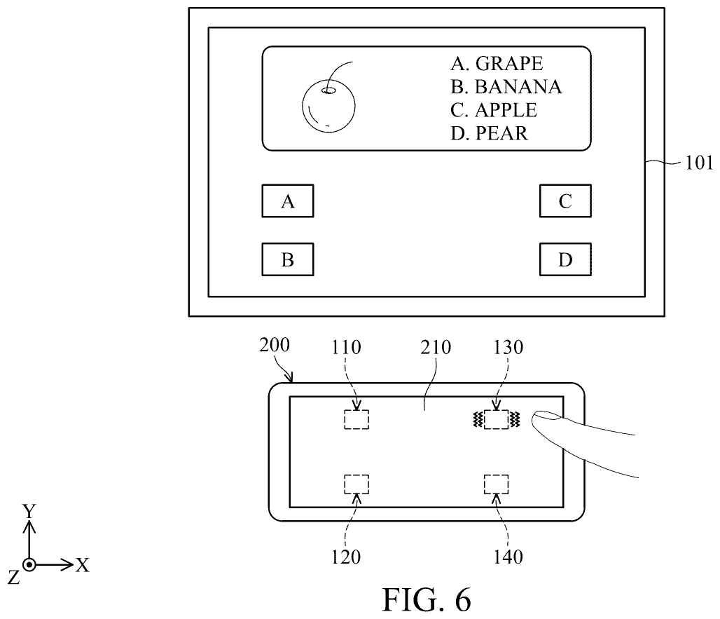

Please refer to FIG. 6 next. FIG. 6 is a schematic diagram showing that the haptic modules generate vibrations in response to an application according to an embodiment of the present disclosure. As shown in FIG. 6, when a user executes a puzzle guessing program, these haptic modules can interact with the user according to the answer of the application program.

For example, the positions of the first haptic module 110 to the fourth haptic module 140 correspond to the position configurations of the answers A to D displayed on the display screen 101, respectively. Therefore, when the user does not answer the question for a period of time, the application currently executed by the portable electronic device 100 will output a prompt signal to the first control circuit 104.

Then, the first control circuit 104 outputs at least one vibration signal (such as a fourth current IC4) to the second vibrator 119 of at least one of the first haptic module 110 to the fourth haptic module 140 according to the prompt signal, so that the second vibrator 119 vibrates to prompt the user. The fourth current IC4 is, for example, an AC signal, but it is not limited thereto.

For example, as shown in FIG. 6, the second vibrator 119 of the third haptic module 130 can generate vibration that is transmitted to the user's finger through the touchpad module 210 of the detachable input device 200 to indicate that the correct answer to the current question is C, but the prompting method is not limited to this embodiment.

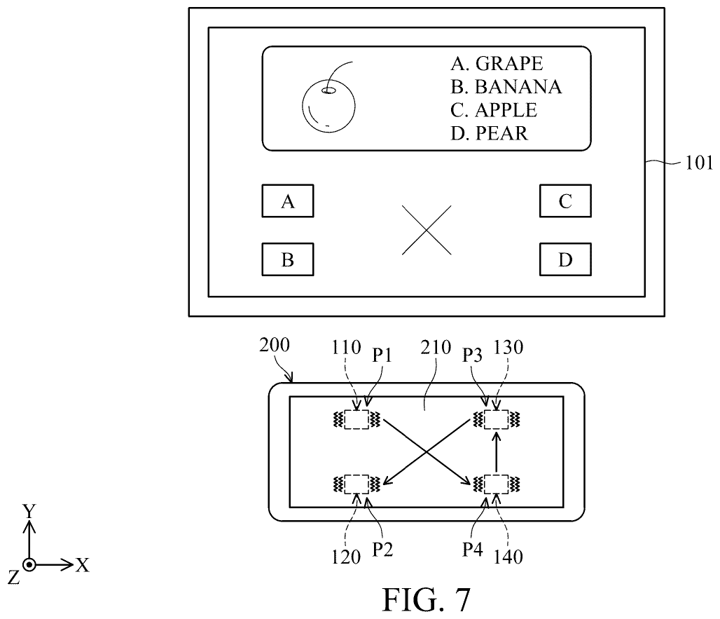

Please refer to FIG. 2 and FIG. 7. FIG. 7 is a schematic diagram showing that the haptic modules generate vibrations in response to an application according to another embodiment of the present disclosure. As shown in FIG. 7, when the user gives a wrong answer, the first control circuit 104 can output a vibration signal (the fourth current IC4) to these haptic modules, so that the first haptic module 110 at the first position P1, the fourth haptic module 140 at the fourth position P4, the third haptic module 130 at the third position P3, and the second haptic module 120 at the second position P2 vibrate in sequence to inform the user that the answer is wrong (as shown in the order of the arrows in FIG. 7).

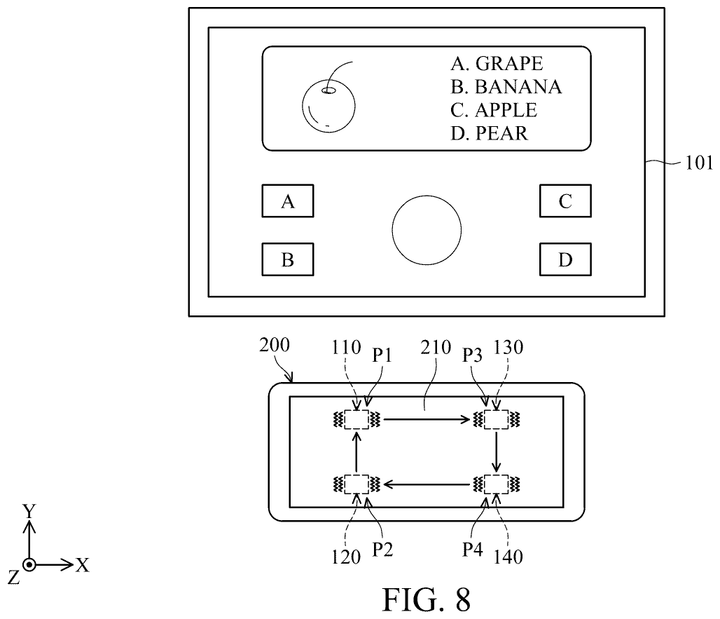

Similarly, please refer to FIG. 2 and FIG. 8. FIG. 8 is a schematic diagram showing that the haptic modules generate vibrations in response to an application according to another embodiment of the present disclosure. As shown in FIG. 8, when the user answers correctly, the first control circuit 104 can output a vibration signal (the fourth current IC4) to the haptic modules, so that the first haptic module 110, the third haptic module 130, the fourth haptic module 140, the second haptic module 120 and the first haptic module 110 vibrate in sequence to inform the user that the answer is correct.

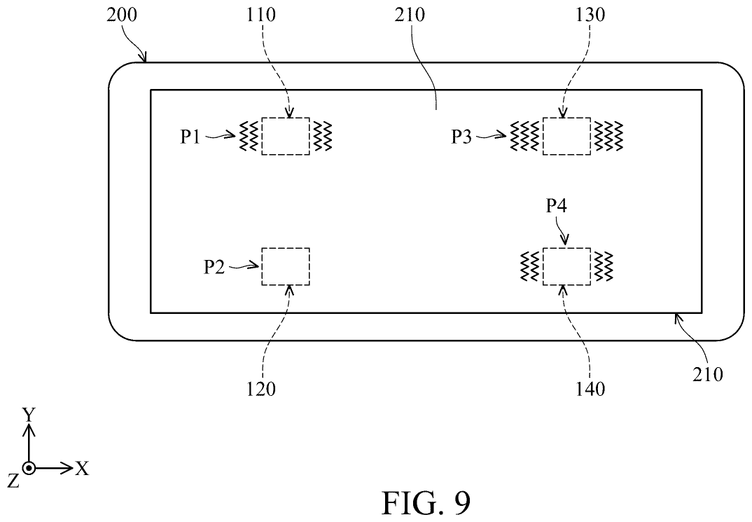

Please refer to FIG. 9 and Table 1. FIG. 9 is a schematic diagram showing that the haptic modules generate vibrations in response to an application according to an embodiment of the present disclosure. The following Table 1 lists a plurality of vibration modes of the haptic modules according to an embodiment of the present disclosure, but they are not limited thereto.

TABLE 1

| | Mode 1 | Mode 2 | Mode 3 | Mode 4 | Mode 5 | Mode 6 |
|---|---|---|---|---|---|---|
| | (Vibration | (Vibration | (Vibration | (Vibration | (Vibration | (Vibration |
| | at upper- | at right | at lower- | at bottom | at lower- | at upper- |
| | right side) | side) | right side) | side) | left side) | left side) |
| vibration at | ◯ | X | X | X | ◯ | ◯ |
| the first | | | | | | |
| position P1 | | | | | | |
| vibration at | ◯ | ◯ | ◯ | X | X | ◯ |
| the third | | | | | | |
| position P3 | | | | | | |
| vibration at | ◯ | ◯ | ◯ | ◯ | ◯ | X |
| the fourth | | | | | | |
| position P4 | | | | | | |
| vibration at | X | X | ◯ | ◯ | ◯ | ◯ |
| the second | | | | | | |
| position P2 | | | | | | |
| magnetic | X | ◯ | ◯ | ◯ | X | X |
| attraction | | | | | | |
| force at the | | | | | | |
| first | | | | | | |
| position P1 | | | | | | |
| magnetic | X | X | X | ◯ | X | X |
| attraction | | | | | | |
| force at the | | | | | | |
| third | | | | | | |
| position P3 | | | | | | |
| magnetic | X | X | X | X | X | ◯ |
| attraction | | | | | | |
| force at the | | | | | | |
| fourth | | | | | | |
| position P4 | | | | | | |
| magnetic | ◯ | ◯ | X | X | ◯ | X |
| attraction | | | | | | |
| force at the | | | | | | |
| second | | | | | | |
| position P2 | | | | | | |

In this embodiment, multiple haptic modules can generate vibrations at the same time, and multiple coils can generate magnetic attraction forces at the same time. In Table 1, O represents that vibration or magnetic attraction force is generated at this position, and X represents that vibration or magnetic attraction force is not generated at this position.

For example, as shown in FIG. 9, in mode 1, the haptic modules at the first position P1, the third position P3, and the fourth position P4 will vibrate, so that the user feels vibration feedback at the upper right corner of the touchpad module 210, but the present disclosure is not limited thereto. For example, the vibration feedback at the upper right position may also be implemented by only generating vibration by the third haptic module 130 at the third position P3. In addition, in mode 1, the vibration generated by the third haptic module 130 may also be greater than the vibrations generated by the other two haptic modules.

Furthermore, in mode 2, the haptic modules at the third position P3 and the fourth position P4 will vibrate, so that the user can feel the vibration feedback at the right side of the touchpad module 210. The other vibration modes are similar and will not be described in detail herein.

It is worth noting that when the second vibrator 119 of the haptic module at a certain position vibrates, the corresponding coil may not be energized. For example, in mode 2, when the haptic modules at the third position P3 and the fourth position P4 generate vibrations, the corresponding third coil CL3 and the fourth coil CL4 are not energized. That is, no magnetic attraction force is generated at the third position P3 and the fourth position P4.

However, the first coil CL1 and the second coil CL2 at the first position P1 and the second position P2 are still energized and have the magnetic attraction force. Based on such a configuration, while ensuring that the detachable input device 200 is fixed in the accommodation recess 1022, the effect of vibration feedback can be further enhanced.

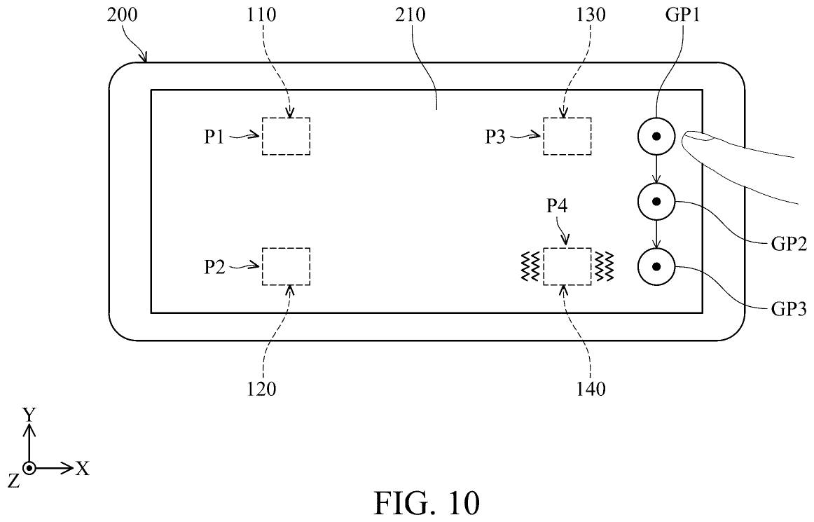

Please refer to FIG. 2 and FIG. 10. FIG. 10 is a schematic diagram showing that the haptic modules generate vibration in response to an operation gesture according to an embodiment of the present disclosure. In this embodiment, the first haptic module 110 to the fourth haptic module 140 can sense the force applied by an external object (such as a finger) to the touchpad module 210.

As shown in FIG. 10, when the finger moves from a first force application position GP1 to a second force application position GP2 and finally stops at a third force application position GP3 on the touchpad module 210, the first control circuit 104 receives sensing signals from the first haptic module 110 to the fourth haptic module 140 and correspondingly outputs a sensing result to the second control circuit 204.

The following Table 2 shows an example of sensing data (the sensing result) sensed by the haptic pressure sensors at different positions in three frames. One frame is, for example, 1/60 second, but it is not limited thereto.

TABLE 2

| | Frame 1 | Frame 2 | Frame 3 |
|---|---|---|---|
| force at first position P1 | 20 g | 15 g | 0 g |
| force at second position P2 | 0 g | 5 g | 20 g |
| force at third position P3 | 50 g | 40 g | 20 g |
| force at fourth position P4 | 20 g | 30 g | 50 g |

After receiving the sensing result, the second control circuit 204 determines that the finger moves from the first force application position GP1, through the second force application position GP2, to the third force application position GP3 according to the sensing result and the touch coordinates (such as two-dimensional coordinates x, y) sensed by the touchpad module 210.

It is worth noting that during the movement of the finger, the second control circuit 204 is configured to compare the aforementioned sensing result sensed by the first haptic module 110 to the fourth haptic module 140 and two-dimensional coordinates with a lookup table 205. The lookup table 205 stores the aforementioned two-dimensional coordinates and data of the sensed force.

After the comparison, the second control circuit 204 transmits a comparison result to the first control circuit 104, and the first control circuit 104 outputs a vibration signal (such as the fourth current IC4) to the second vibrator 119 in at least one of the first haptic module 110 to the fourth haptic module 140 according to the comparison result before (or at the same time) the external object reaches the third force application position GP3. In this embodiment, the fourth current IC4 is output to the second vibrator 119 of the fourth haptic module 140 to generate vibration.

The position of the second vibrator 119 of the fourth haptic module 140 that receives the fourth current IC4 corresponds to the third force application position GP3. Based on such a configuration, vibration feedback can be given to the user in a timely manner when the user's finger reaches the third force application position GP3. Such vibration feedback can prompt the user that the gesture has been successfully completed.

It is worth noting that this gesture can be used to trigger the aforementioned release signal RSG. For example, when the gesture is completed and vibration feedback is generated, the first control circuit 104 sends the release signal RSG to the second control circuit 204 to control the second magnetic module 250 to generate the magnetic repulsive force to release the detachable input device 200.

In addition, in other embodiments, the lookup table 205 can also be stored in the portable electronic device 100, and the first control circuit 104 can perform comparison and perform subsequent vibration control.

In conclusion, the present disclosure provides a portable electronic device 100, which may include a housing 102 and a detachable input device 200. The detachable input device 200 is detachably installed in an accommodation recess 1022 of the housing 102. When the detachable input device 200 is installed in the housing 102, the second magnetic module 250 of the detachable input device 200 may generate a magnetic attraction force with the first magnetic module 150 in the housing 102, so that the detachable input device 200 may be fixed in the accommodation recess 1022.

When the user wants to remove the detachable input device 200 from the accommodation recess 1022, the user can perform an operation gesture on the touchpad module 210 to trigger the second magnetic module 250 and the first magnetic module 150 to generate a magnetic repulsive force, thereby pushing the detachable input device 200 out of the accommodation recess 1022. In addition, a first vibrator 240 is disposed in the detachable input device 200, and a plurality of haptic modules are further disposed in the housing 102, each of which has a second vibrator 119.

When the user operates the touchpad module 210 of the detachable input device 200 and executes a specific application, in certain scenarios of the application, the application will send a signal to notify the first control circuit 104 and the second control circuit 204 to control the first vibrator 240 and the second vibrator 119 to generate vibration together. Since the vibration generated by the second vibrator 119 can be superimposed on the vibration generated by the first vibrator 240 (for example, the phases of the two vibrators are substantially the same), it can provide the user with more obvious vibration feedback, thereby solving the problem of insufficient vibration feedback of a single vibrator.

Although the embodiments and their advantages have been described in detail, it should be understood that various changes, substitutions, and alterations can be made herein without departing from the spirit and scope of the embodiments as defined by the appended claims. Moreover, the scope of the present application is not intended to be limited to the particular embodiments of the process, machine, manufacture, composition of matter, means, methods, and steps described in the specification. As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein can be utilized according to the disclosure. Accordingly, the appended claims are intended to include within their scope such processes, machines, manufacture, compositions of matter, means, methods, or steps. In addition, each claim constitutes a separate embodiment, and the combination of various claims and embodiments are within the scope of the disclosure.

What is claimed is:

1. A portable electronic device, comprising:
a housing, having an upper surface and an accommodation recess, wherein the accommodation recess is recessed from the upper surface;
a first magnetic module, disposed in the housing; and
a detachable input device, detachably installed in the accommodation recess or separated from the accommodation recess, wherein the detachable input device has a second magnetic module;
wherein when the detachable input device is installed in the accommodation recess, the portable electronic device provides an activation signal to the detachable input device so that the second magnetic module is activated and generates a magnetic attraction force with the first magnetic module to fix the detachable input device in the accommodation recess.

2. The portable electronic device as claimed in claim 1, wherein the portable electronic device further includes a first control circuit, the detachable input device further includes a second control circuit, and when the second control circuit receives the activation signal from the first control circuit, the second control circuit provides a first current to the second magnetic module to generate the magnetic attraction force.

3. The portable electronic device as claimed in claim 2, wherein when the second control circuit receives a release signal from the first control circuit, the second control circuit provides a second current to the second magnetic module to generate a magnetic repulsive force between the second magnetic module and the first magnetic module, thereby driving the detachable input device to detach from the accommodation recess, wherein a direction of the second current is opposite to a direction of the first current.

4. The portable electronic device as claimed in claim 2, wherein the second magnetic module has a first coil to a fourth coil, the first coil and the second coil are located on a first side, the third coil and the fourth coil are located on a second side, and the second side is opposite to the first side.

5. The portable electronic device as claimed in claim 4, wherein when the second control circuit receives a release signal from the first control circuit, the second control circuit provides a second current to the first coil and the second coil to generate a first magnetic repulsive force between the combination of the first coil and the second coil, and the first magnetic module, and the second control circuit further provides a third current to the third coil and the fourth coil to generate a second magnetic repulsive force between the combination of the third coil and the fourth coil, and the first magnetic module.

6. The portable electronic device as claimed in claim 5, wherein a direction of the third current is the same as a direction of the second current, the direction of the second current is opposite to a direction of the first current, and the second magnetic repulsive force is greater than the first magnetic repulsive force.

7. The portable electronic device as claimed in claim 4, wherein the first magnetic module has four magnetic components corresponding respectively to the first coil to the fourth coil, and the portable electronic device further includes a first haptic module to a fourth haptic module respectively connected to the four magnetic components.

8. The portable electronic device as claimed in claim 7, wherein each of the first haptic module to the fourth haptic module has a haptic pressure sensor which is configured to sense a force applied by an external object to the detachable input device.

9. The portable electronic device as claimed in claim 8, wherein each of the first haptic module to the fourth haptic module further includes an insulation component which is disposed between the corresponding haptic pressure sensor and the magnetic component, wherein the insulation component is made of a non-magnetic material.

10. The portable electronic device as claimed in claim 9, wherein each of the first haptic module to the fourth haptic module further has a transmit element which is connected between the corresponding haptic pressure sensor and the magnetic component.

11. The portable electronic device as claimed in claim 10, wherein each of the first haptic module to the fourth haptic module further has a positioning component which is fixedly disposed on the corresponding haptic pressure sensor, the transmit element has a columnar structure, and the positioning component is configured to position the transmit element.

12. The portable electronic device as claimed in claim 11, wherein the detachable input device further includes a first vibrator, each of the first haptic module to the fourth haptic module further includes a second vibrator, and vibration generated by the second vibrator is superimposed on vibration generated by the first vibrator.

13. The portable electronic device as claimed in claim 12, wherein the detachable input device further includes a touchpad module, and when the first haptic module to the fourth haptic module sense that the external object applies a force to the touchpad module and moves from a first force application position to a second force application position and finally stops at a third force application position on the touchpad module, the first control circuit receives sensing signals from the first haptic module to the fourth haptic module and correspondingly outputs a sensing result to the second control circuit.

14. The portable electronic device as claimed in claim 13, wherein the second control circuit is configured to compare the sensing result with a lookup table to obtain a comparison result, and the first control circuit outputs a vibration signal to the second vibrator in at least one of the first haptic module to the fourth haptic module according to the comparison result before the external object reaches the third force application position.

15. The portable electronic device as claimed in claim 14, wherein the position of the second vibrator that receives the vibration signal corresponds to the third force application position.

16. The portable electronic device as claimed in claim 12, wherein an application executed by the portable electronic device is configured to output a prompt signal to the first control circuit, and the first control circuit outputs at least one vibration signal to the second vibrator of at least one of the first haptic module to the fourth haptic module according to the prompt signal, so that the second vibrator vibrates.

17. The portable electronic device as claimed in claim 1, wherein the detachable input device has a top surface and a bottom surface, and the top surface is opposite to the bottom surface, wherein a touchpad module is disposed on the top surface, and a button module is disposed on the bottom surface.

18. The portable electronic device as claimed in claim 17, wherein when the detachable input device is installed in the accommodation recess, the touchpad module of the detachable input device provides a touchpad function, and when the detachable input device is separated from the accommodation recess, the button module of the detachable input device provides a button input function which is configured to provide an input signal to the portable electronic device in a wireless manner.

19. The portable electronic device as claimed in claim 1, wherein a first connector is disposed in the accommodation recess and has a plurality of first electrical contacts, and a second connector is disposed on the detachable input device and has a plurality of second electrical contacts, wherein when the detachable input device is installed in the accommodation recess, the second electrical contacts are in contact with and are electrically connected to the first electrical contacts, so that the portable electronic device sends the activation signal accordingly.

20. The portable electronic device as claimed in claim 19, wherein the first connector or the second connector is a pogo pin connector.
